(19) United States
(12) Patent Application Publication
(10) Pub. No.: US 2014/0014539 A1
(43) Pub. Date: Jan. 16, 2014

(54) System and Method for Providing Removable Eraseable Writing Surface

(71) Applicant: Anat Jatwes, Boca Raton, FL (US)

(72) Inventor: Anat Jatwes, Boca Raton, FL (US)

(21) Appl. No.: 13/938,837

(22) Filed: Jul. 10, 2013

Related U.S. Application Data
(60) Provisional application No. 61/670,842, filed on Jul. 12, 2012.

(51) Int. Cl. B43L 1/00; A45C 11/34

(52) U.S. Cl. CPC B43L 1/00; A45C 11/34
USPC 206/223; 434/408

(57) ABSTRACT

The present invention is a system for utilizing a base article with a removable erasable writing surface, said system comprising a base article, a mechanism constructed and arranged for securing a dry erase board to said base article, a dry erase board constructed and arranged to be removably attached to said base article utilizing said attaching mechanism, wherein said system provides an erasable surface.

### INDEX TO RELATED APPLICATIONS

This application is a non-provisional of, and claims benefit to U.S. Provisional Patent Application Ser. No. 61/670,842 filed Jul. 12, 2012 the disclosure of which is incorporated herein by reference in its entirety.

### BACKGROUND OF THE INVENTION

Often, students will take articles to school for various convenience reasons. One of the staples of school supplies includes a pencil box/storage box. Parents often wish for students to keep their supplies clean and in good order. Most often, students that tend to doodle end up writing on their pencil boxes and binders and other supplies. The present invention addresses a need whereby a student has an erasable dry erase surface removably secured to a base article such as a pencil box, storage box, binder and the like such that the student is able to doodle and erase repeatedly.

### SUMMARY OF THE INVENTION

The present invention relates to putting removable eraseable inserts on the sides of boxes of different shapes, binders, shelfs or books. These inserts allow dry erase magnetic boards or other erasable surface items to slide in. The sliding boards will be in different designs with matching magnets so you can collect as many as you want.

The uses include, but are not limited to:
Pencil box
Utility boxes
Different sizes containers
Cabinets
Binders
Organizers
calendars

The special insert allows the users to fit in a dry erase board.

Pencil box will allow children to practice writing, solve math problems or use their imagination to doodle. The dry erase boards will be able to slide in or out of the box and the different designs will make it a collectable item with different types of magnets on it.

First the box will come as a starter's kit. This kit will include a box molded with the inserts, a dry erase marker with an attached eraser and a basic dry erase board with basic pencil shaped magnets. Sold separately will be different designs of the dry erase boards containing different types of magnets on them.

Binders: binders will have the insert attached on the inside of the binder with a dry erase board fitting the size of the insert. This can be used in school for drafts, solving math problems, doodling and for writing down homework assignments.

Organizers: Day planners and appointment books will come with the insert and the dry erase board that fits in them. This can be used for memos sketching or writing messages on.

Containers: different sizes containers used for storage (such as cloth, toys, pictures, documents, medicines, food, etc.) will come with the insert on the box and the matching size dry erase board. this will be used to describe the items in the box or to put different messages on it.

Cabinets: here the insert will be sold on its own with no box just the dry erase board that fit it. This will be used to attach on the inside of cabinets around the house to write important memos on it.

Calendars: calendars for hanging up will have on the side an extra board with the insert on it. A dry erase board will come with magnets on it this can be used to hang up important notes with the magnets and write messages on.

Tablet computer cover: insert on the inside of the tablet cover.

### BRIEF DESCRIPTION OF THE SEVERAL VIEWS OF THE DRAWING

FIG. 1 is a top view of the present invention.

FIG. 2 is a front view of the present invention showing a dry erase board sliding into a secured position along a pair of complementary guidance tracks.

FIG. 3 is a rear view of the present invention.

FIG. 4 is a right side view of the present invention.

FIG. 5 is a left side view of the present invention.

FIG. 6 a bottom view of the present invention.

FIG. 7 is a section line along section A-A of FIG. 1 exemplifying an embodiment whereby a dry erase board is secured to a storage box according to the present invention.

FIG. 8 is a section line along section B-B of FIG. 1 showing the dry erase board and sliding method in relation to a latch mechanism of a box according to the present invention.

FIG. 9 is a section view line along section C-C of FIG. 1 showing the dry erase board and sliding arrangement along with a living hinge on a box according to the present invention.

FIG. 10 a top view of a dry erase board arranged according to the present invention.

FIG. 11 is a front view of the dry erase board according to the present invention.

FIG. 12 a side view of the dry erase board according to the present invention.

FIG. 13 is an example of a securing method whereby a dry erase board slides into a recess constructed and arranged to receive the board according to the present invention.

FIG. 14 is an embodiment demonstrating a dry erase board and said dry erase board having an element of magnetism for securing magnetic particles thereon.

### DETAILED DESCRIPTION OF THE PREFERRED EMBODIMENT

Although, as discussed herein, the invention in general terms as illustrated is a dry erase board removably secured to a pencil storage box, it is contemplated that the present invention may be utilized in a variety of configurations. The configurations contemplated include but are not limited to, school supply items such as a pencil box, or other storage box, a binder, a backpack, and other such articles as are usually utilized by school children. Additionally, the present invention would not be limited to use by school children, and can be utilized in any configuration whereby a dry erase board is removably attached to an article. As best shown in the figures the system 10 includes a storage box 12. Storage box 12 is constructed and arranged with a pair of complimentary slide rails 26 each with a slide rail contact surface 24 constructed and arranged for contact and securing dry erase board 14. As is known in the art, a pencil box is constructed and arranged with a living hinge 18 on one longitudinal side of said box and a latch 16 typically placed opposite living hinge 18.

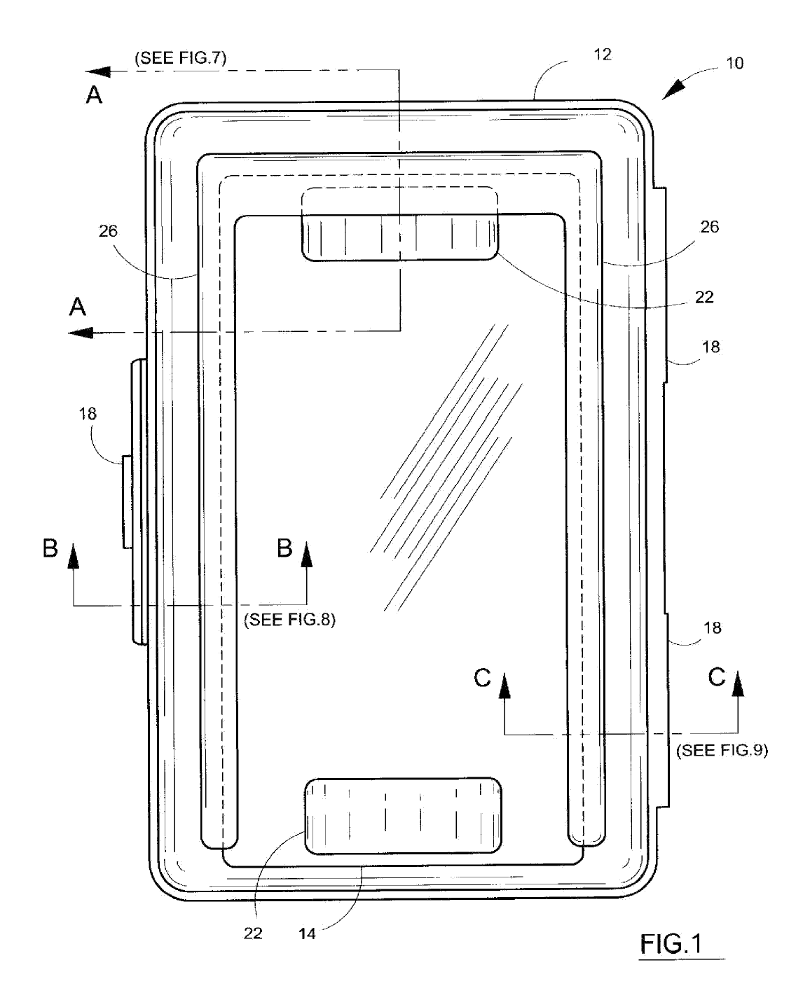

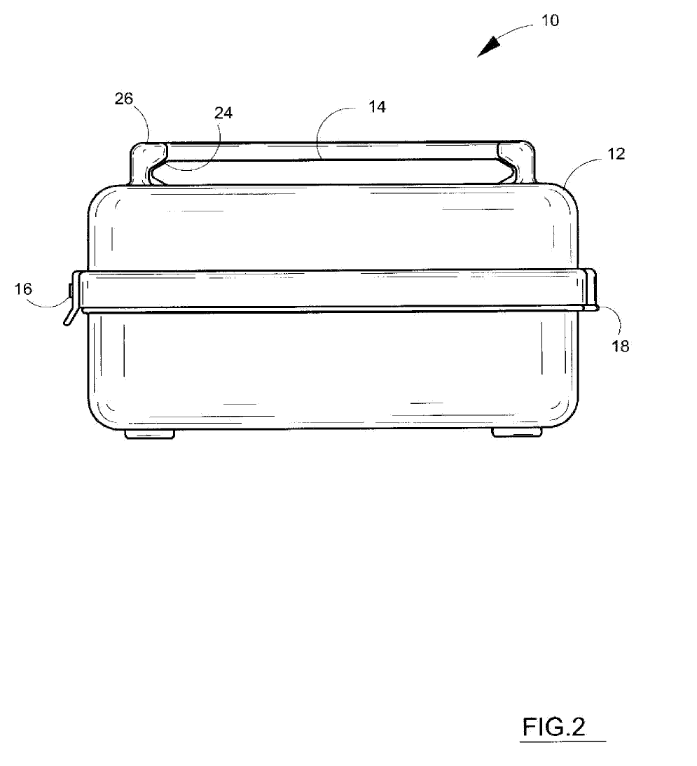

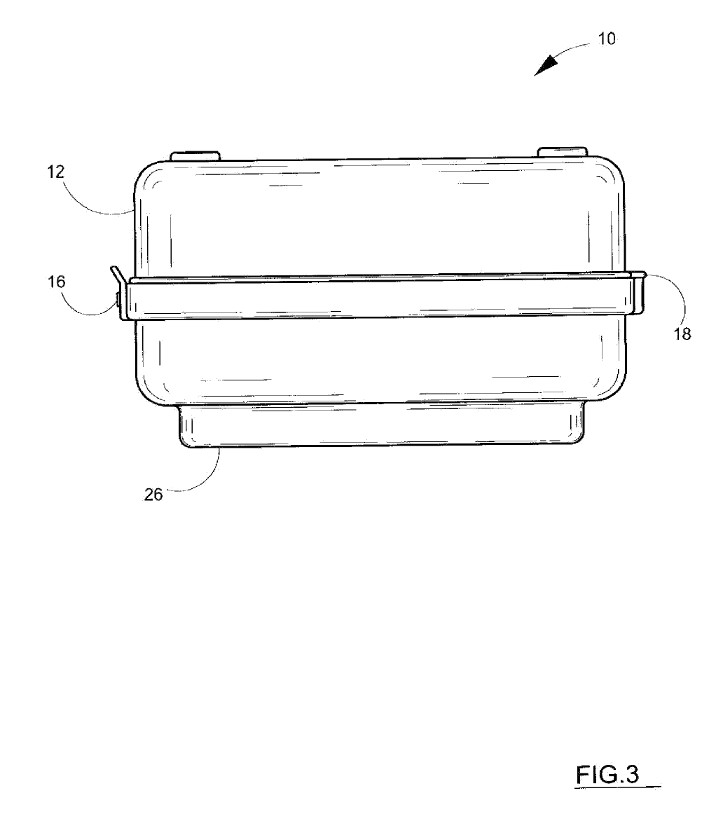

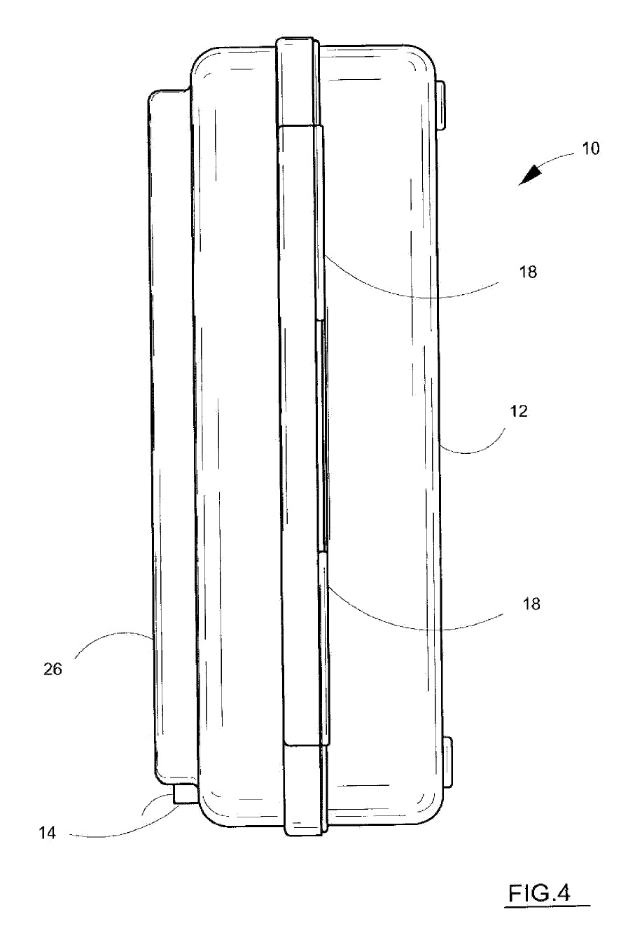

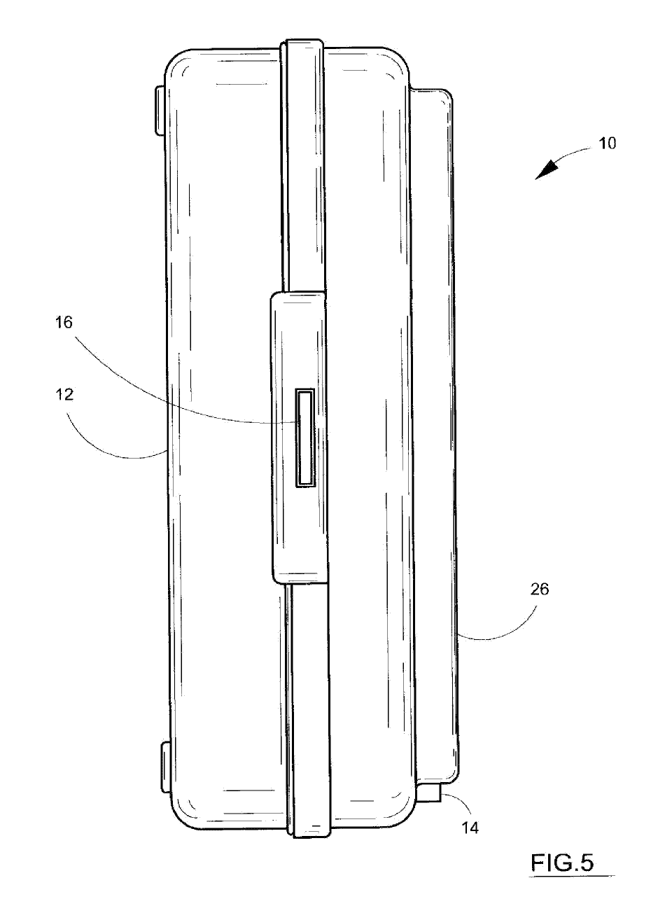

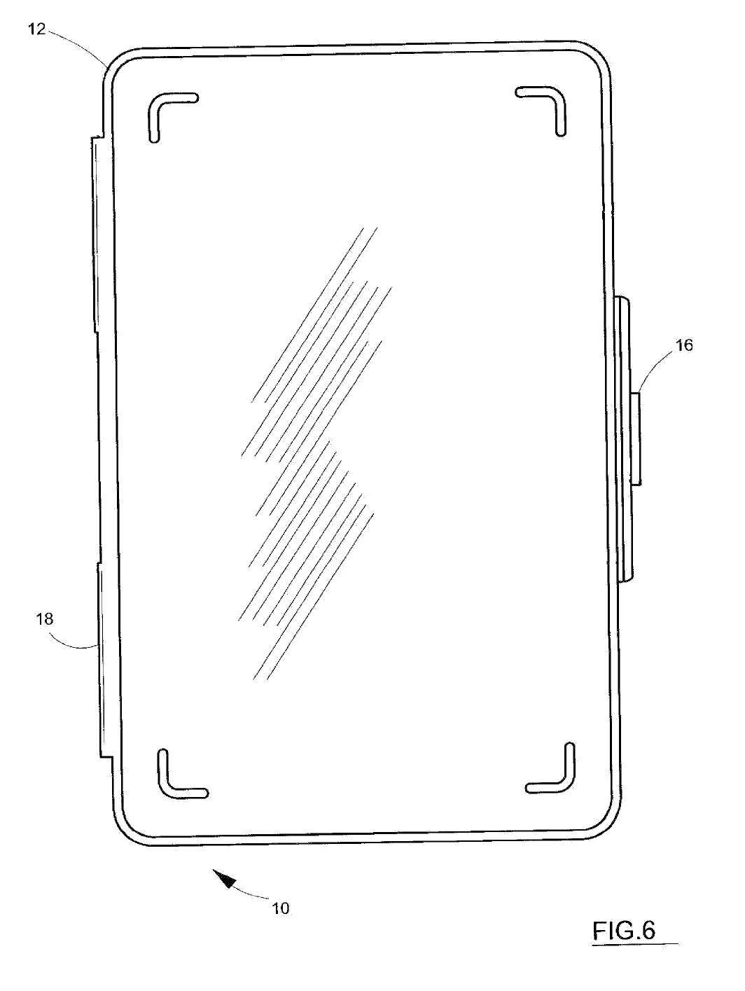

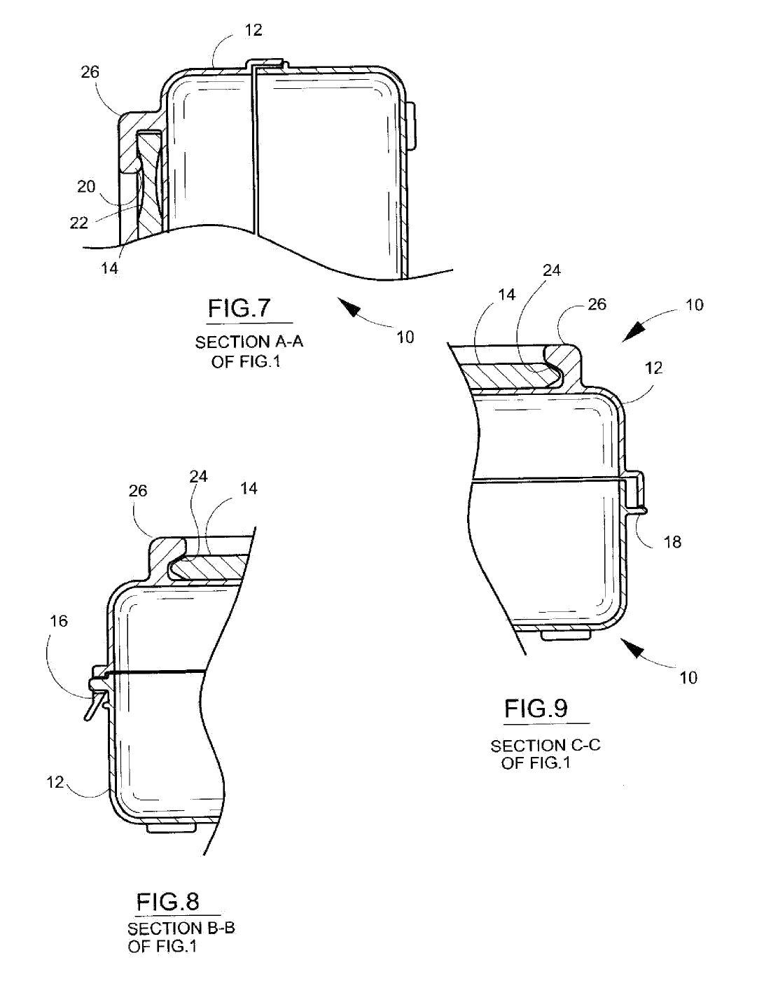

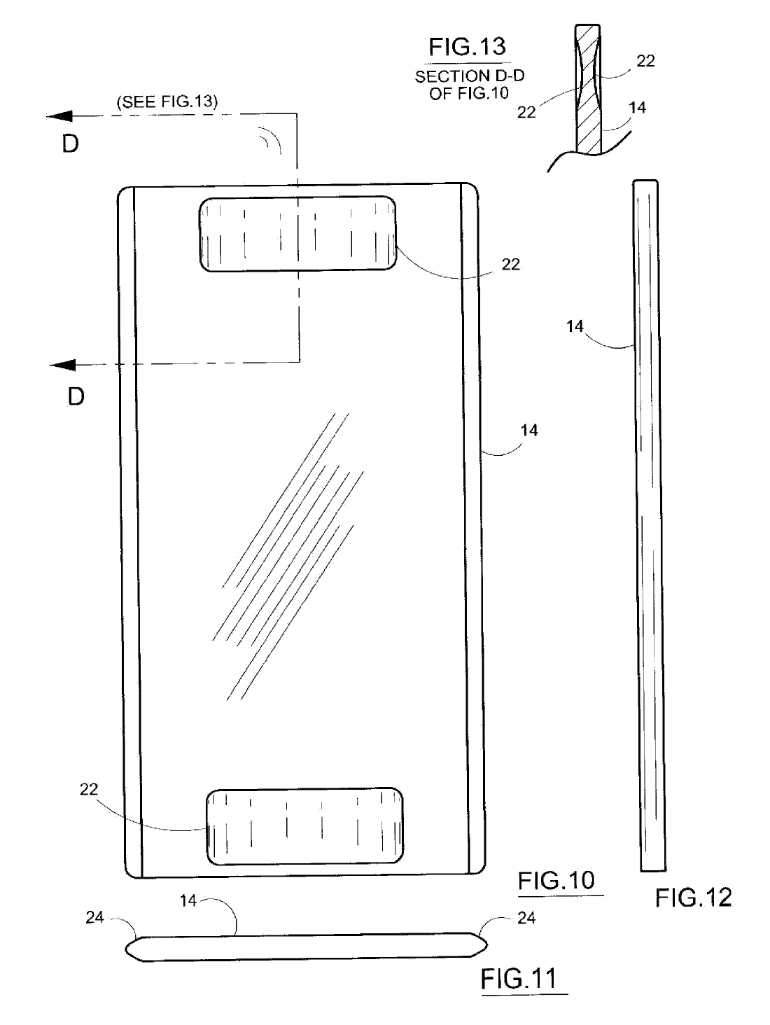

As best seen in FIG. 1 and FIG. 7 dry erase board 14 is constructed and arranged having a recessed retainer portion 12 that interacts with flexible retainer 20 in order to removably secure dry erase board 14 within complimentary slide rails 26.

In use, dry erase board 14 is positioned between each of complimentary slide rails 26, dry erase board 14 is slid into position and as shown in in FIG. 7 when recessed retainer surface 22 contacts flexible retainer 20, dry erase board 14 is secured into position. As best demonstrated in FIG. 8, recessed retainer portion 22 is constructed and arranged such that it will interact and lock dry erase board 14 into position as described. Recessed portion 22 can be constructed and arranged to encompass any number of positions including one side of one surface, two sides of one surface, one side on a first surface and an opposing second surface of dry erase board 14, two sides of two opposing surfaces of dry erase board 14 and combinations thereof. The dry erase board must have at least one recessed surface 22 in order to secure into position as described herein.

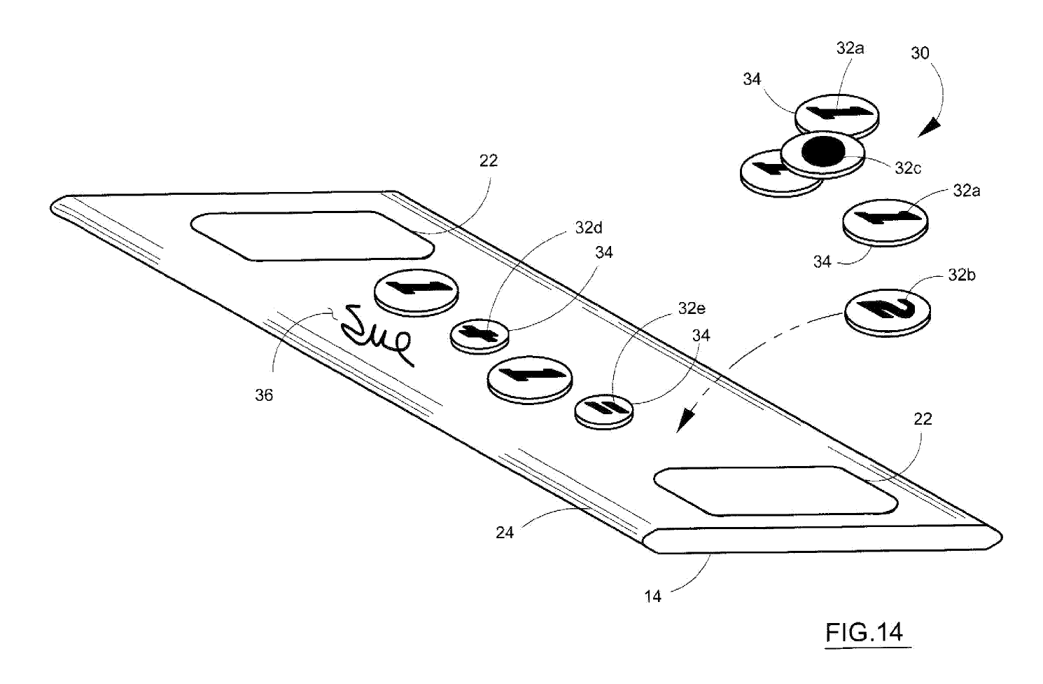

In one embodiment, as demonstrated in FIG. 14, dry erase board has a writable/erasable dry erase surface 36 as is known in the art. Surface 36 of dry erase board 14 can be constructed and arranged with a magnetic surface such that a plurality of icons 34 with surface images 32a, 32b, 32c, 32d and 32e (representative only of surface designs) of magnetic icon 34 can be placed and removed from surface 36 of dry erase board 14.

While the invention has been described in its preferred form or embodiment with some degree of particularity, it is understood that this description has been given only by way of example and that numerous changes in the details of construction, fabrication, and use, including the combination and arrangement of parts, may be made without departing from the spirit and scope of the invention.

I claim:

1. A system for utilizing a base article with a removable erasable writing surface, said system comprising:
a base article;
a mechanism constructed and arranged for securing a dry erase board to said base article;
a dry erase board constructed and arranged to be removably attached to said mechanism;
wherein said system provides an erasable surface.

2. The system of claim 1 whereby said dry erase board further is constructed and arranged such that magnetic articles can be attached thereon.

3. The system of claim 1, wherein said dry erase board has at least one convex indented surface constructed and arranged to interact with a flexible retainer portion.

4. The system of claim 1 wherein said base article is Pencil box, Utility boxes, Different sizes containers, Cabinets, Binders, Organizers, or calendars
